(19) United States
(12) Patent Application Publication
(10) Pub. No.: US 2012/0059918 A1
(43) Pub. Date: Mar. 8, 2012

(54) LOCATION BASED SERVICE DATA CONNECTION SUPPORT ACROSS MULTIPLE PROFILES

(75) Inventors: Prasad Gadde, Hyderabad (IN); Debesh Kumar Sahu, Hyderabad (IN); Parmjeet Singh, New Delhi (IN)

(73) Assignee: QUALCOMM Incorporated, San Diego, CA (US)

(21) Appl. No.: 12/877,543

(22) Filed: Sep. 8, 2010

(51) Int. Cl. G06F 15/173

(52) U.S. Cl. 709/223

(57) ABSTRACT

In a wireless data packet network, a single mobile device is provisioned to support a plurality of user profiles including a service or application that can be associated to multiple profiles. Arbitration for requests for a data connection can be made based upon priority, with applications having the same priority allowed to share the data connection. In some instances, the profile used to establish the data connection does not support the application that can be associated to multiple profiles, such as Location Based Services (LBS). To minimize subsequent rejections of requests for a data connection by the LBS, capability scans or updates determine what services are supported by the currently active profiles.

### BACKGROUND

1. Field

The present disclosure relates to a mobile operating environment, and more particularly, to maintaining a data packet connection across multiple applications.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Universal Mobile Telecommunications System (UMTS) is one of the third-generation (3G) cell phone technologies. UTRAN, short for UMTS Terrestrial Radio Access Network, is a collective term for the Node-B's and Radio Network Controllers which make up the UMTS radio access network. This communications network can carry many traffic types from real-time Circuit Switched to IP based Packet Switched. The UTRAN allows connectivity between the UE (user equipment) and the core network. The RNC provides control functionalities for one or more Node Bs. A Node B and an RNC can be the same device, although typical implementations have a separate RNC located in a central office serving multiple Node B's. Despite the fact that they do not have to be physically separated, there is a logical interface between them known as the Iub. The RNC and its corresponding Node Bs are called the Radio Network Subsystem (RNS). There can be more than one RNS present in an UTRAN.

CDMA2000 (also known as IMT Multi Carrier (IMT MC)) is a family of 3G mobile technology standards, which use CDMA channel access, to send voice, data, and signaling data between mobile phones and cell sites. The set of standards includes: CDMA2000 1×, CDMA2000 EV-DO Rev. 0, CDMA2000 EV-DO Rev. A, and CDMA2000 EV-DO Rev. B. All are approved radio interfaces for the ITU's IMT-2000. CDMA2000 has a relatively long technical history and is backward-compatible with its previous 2G iteration IS-95 (cdmaOne).

CDMA2000 1× (IS-2000), also known as 1× and 1×RTT, is the core CDMA2000 wireless air interface standard. The designation “1×”, meaning 1 times Radio Transmission Technology, indicates the same RF bandwidth as IS-95: a duplex pair of 1.25 MHz radio channels. 1×RTT almost doubles the capacity of IS-95 by adding 64 more traffic channels to the forward link, orthogonal to (in quadrature with) the original set of 64. The 1× standard supports packet data speeds of up to 153 kbps with real world data transmission averaging 60-100 kbps in most commercial applications. IMT-2000 also made changes to the data link layer for the greater use of data services, including medium and link access control protocols and Quality of Service (QoS). The IS-95 data link layer only provided “best effort delivery” for data and circuit switched channel for voice (i.e., a voice frame once every 20 ms).

CDMA2000 1×EV-DO (Evolution-Data Optimized), often abbreviated as EV-DO or EV, is a telecommunications standard for the wireless transmission of data through radio signals, typically for broadband Internet access. It uses multiplexing techniques including code division multiple access (CDMA) as well as time division multiple access (TDMA) to maximize both individual user's throughput and the overall system throughput. It is standardized by 3rd Generation Partnership Project 2 (3GPP2) as part of the CDMA2000 family of standards and has been adopted by many mobile phone service providers around the world, particularly those previously employing CDMA networks.

3GPP LTE (Long Term Evolution) is the name given to a project within the 3rd Generation Partnership Project (3GPP) to improve the UMTS mobile phone standard to cope with future requirements. Goals include improving efficiency, lowering costs, improving services, making use of new spectrum opportunities, and better integration with other open standards. The LTE system is described in the Evolved UTRA (EUTRA) and Evolved UTRAN (EUTRAN) series of specifications.

In addition to voice services, mobile devices are increasingly being used for data packet services such as Internet Protocol (IP) web browsing, and data burst messages such as Short Message Service (SMS) text messaging and Media Message Service (MMS) messaging, etc. Further, Location Based Services (LBS) are a popular feature provided by many wireless mobile devices for navigation utilities, social networking based on geography, directory information for local goods and services, etc. Often, such LBS applications can share an existing data connection to maintain such guidance without interfering with other data packet services.

One way in which multiple data packet services are managed is by provisioning a mobile device with subscriber identification. In order for handsets to interface with subscriber networks, subscriber identification carried by the handset is required. For example, a Subscriber Identity Module (SIM) on a removable SIM card securely stores the service-subscriber key for identification purposes on mobile telephony devices (such as mobile phones and computers). The SIM card allows users to change phones by simply removing the SIM card from one mobile phone and inserting it into another mobile phone or broadband telephony device.

A SIM card contains its unique serial number, International Mobile Subscriber Identifier (IMSI) of the mobile device, security authentication and ciphering information, temporary information related to the local network, a list of the services the user has access to and two passwords (Personal Identification Number (PIN) for usual use and Personal Unblocking Key (PUK) for unlocking).

Each SIM card stores a unique International Mobile Subscriber Identity (IMSI), of this number format: (a) The first 3 digits represent the Mobile Country Code (MCC); (b) The next two or three digits represent the Mobile Network Code (MNC); (c) The remaining digits represent the Mobile Station Identification (MSID) number; and (d) A SIM card also has an Integrated Circuit Card Identification (ICC-ID) number.

A virtual SIM is a mobile phone number provided by a mobile network operator that does not require a SIM card to terminate phone calls on a user's mobile phone.

A RUIM card (also R-UIM) or Removable User Identification Module, is a removable smart card for cellular phones made for the CDMA2000 network. The R-UIM is essentially the 3GPP/ETSI SIM for CDMA2000 systems—which are both based on the Integrated Circuit Card (ICC). The RUIM card holds a user's personal information such as name and account number, cell phone number, phone book, text messages and other settings.

A CDMA2000 Subscriber Identify Module (CSIM) is an application that runs on the newer smart card known as the Universal Integrated Circuit Card (UICC). The UICC can store a CSIM application, USIM application, SIM and/or R-UIM and can be used to enable operation with cellular networks globally. UICC carries the Application Directory Files (ADF) of CSIM and USIM and others. SIM and R-UIM are legacy cards based on ICC. Both SIM and R-UIM can be added on to the UICC but not as an ADF but as a DF (Directory File). The UICC which can carry a CSIM application allows users to change phones by simply removing the smart card from one mobile phone and inserting it into another mobile phone or broadband telephony device.

A separate mobile device with a dedicated cell number is conventionally deployed. In some instances, a dual mode can support multiple radio access technologies to expand opportunities for coverage. Generally, users have separate user equipment or mobile device with a dedicated user profile, which applies even for subscriber calling/data plans with shared usage billing. This can lead to a proliferation of wireless mobile devices. For instance, a user may carry a first device for receiving emails and interacting with office scheduling utilities, etc. The same user can have a cellphone for personal calls. The same user can have a 3G-enabled laptop or tablet device. Thereby, the user can utilize an appropriate user interface with billing and authorized services that are physically separated.

It can be inconvenient or impractical for a user or even a group of users to have multiple wireless devices. In economically developing area, for example, the cost of such services can be prohibitive. Different users can hope to share one device.

Open Market Handsets (OMH) is an initiative led by the CDMA Development Group (CDG). OMH recently has introduced a concept to allow network operators to configure and support different multiple Simple Internet Protocol (SIP)/Mobile Internet Protocol (MIP) profiles to distinguish different kinds of data calls for billing purposes, usage statistics, to satisfy specific data rate, and specific bearer technology requirements. Multiple profiles can also be used to route data traffic differently for different kind of applications. For example, a Wireless Application Protocol (WAP) client can have a need to go through a WAP server, so a local IP Address may be used whereas a tethered data call may need a public IP address. Different profiles can also be used to control different data applications when run simultaneously through application priority control.

It is possible that most commonly and widely used applications such as LBS can reside in multiple profiles. When multiple profiles with same priority are provisioned, then LBS should not be dishonored due to incompatibility with the current active profile, even though other LBS compatible profiles of same priority exists.

At present LBS is the only application which can reside in all or few profiles, but in the future it can be expected that additional requirements to support more such applications may come from network operators. Some of these applications can be mutually exclusive.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method is provided for application sharing of a data packet connection using a device provisioned with a plurality of user profiles. A data connection is maintained from user equipment to support one or more services, each service associated with at least one of a plurality of user profiles. A supporting one is identified of the plurality of user profiles associated with a service defined for association with multiple user profiles. The data connection is shared with the service defined for association with multiple profiles using the supporting one of the plurality of user profiles.

In another aspect, at least one processor is provided for application sharing of a data packet connection using a device provisioned with a plurality of profiles. A first module maintains a data connection from user equipment to support one or more services, each service associated with at least one of a plurality of user profiles. A second module identifies a supporting one of the plurality of user profiles associated with a service defined for association with multiple user profiles. A third module shares the data connection with the service defined for association with multiple profiles using the supporting one of the plurality of user profiles.

In an additional aspect, a computer program product is provided for application sharing of a data packet connection using a device provisioned with a plurality of profiles. A non-transitory computer-readable storage medium comprises sets of codes. A first set of codes causes a computer to maintain a data connection from user equipment to support one or more services, each service associated with at least one of a plurality of user profiles. A second set of codes causes the computer to identify a supporting one of the plurality of user profiles associated with a service defined for association with multiple profiles. A third set of codes causes the computer to share the data connection with the service defined for association with multiple profiles using the supporting one of the plurality of user profiles.

In a further aspect, an apparatus is provided for application sharing of a data packet connection using a device provisioned with a plurality of profiles. Means are provided for maintaining a data connection from user equipment to support one or more services, each service associated with at least one of a plurality of user profiles. Means are provided for identifying a supporting one of the plurality of user profiles associated with a service defined for association with multiple profiles. Means are provided for sharing the data connection with the service defined for association with multiple profiles using the supporting one of the plurality of user profiles.

In yet another aspect, an apparatus is provided for application sharing of a data packet connection using a device provisioned with a plurality of profiles. A transceiver maintains a data connection from user equipment to support one or more services, each service associated with at least one of a plurality of user profiles. A computing platform identifies a supporting one of the plurality of user profiles associated with a service defined for association with multiple profiles, and shares the data connection with the service defined for association with multiple profiles using the supporting one of the plurality of user profiles.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a schematic diagram of a communication system of user equipment using a shared data connection to a Radio Access Network (RAN).

FIG. 2 illustrates a flow diagram for a methodology for enhanced support for Location Based Services (LBS).

FIG. 3 illustrates a flow diagram for an alternate methodology for addressing services in multiple profiles.

FIG. 4 depicts a data structure for additional features of an Elementary File for Simple Internet Protocol/Mobile Internet Protocol User Profiles.

FIG. 5 illustrates a flow diagram for a methodology for dynamically updating a connection record.

FIG. 6 illustrates an exemplary timing diagram for dynamically updating the connection record.

FIG. 7 illustrates a flow diagram for a methodology for generating and using a global application type bitmask.

FIG. 8 illustrates an exemplary timing diagram for generating and using a global application type bitmask.

FIG. 9 illustrates a flow diagram for a methodology for application sharing of a data packet connection using a device provisioned with a plurality of profiles.

FIG. 10 illustrates a schematic diagram of a system including logical groupings of electrical components for application sharing of the data packet connection using a device provisioned with a plurality of profiles.

FIG. 11 illustrates a schematic diagram of an apparatus including means for application sharing of the data packet connection using a device provisioned with a plurality of profiles.

FIG. 12 illustrates a schematic diagram of a multiple access wireless communication system.

FIG. 13 illustrates a schematic diagram of two nodes for multiple input multiple output wireless communication.

### DETAILED DESCRIPTION

The present innovation maximizes services of Location Based Services (LBS) Applications that exist in more than one profile. In one aspect, dynamic updating of a connection record detects opportunities to share a data connection, avoiding rejection of a request by an LBS application. In another aspect, global application type bitmask usage can afford opportunities to share a data connection, avoiding rejection of a request by an LBS application.

In one aspect, an operator can configure LBS in the APPLICATIONS field (e.g., a bit mask) of an Elementary File (EF) for Simple Internet Protocol/Mobile Internet Protocol User Profile Parameters Extension (EF_{SIPUPPExt}) for all those profiles wherein LBS can share data sessions with the rest of the applications included in the APPLICATIONS field. For example, if the APPLICATIONS field of a profile contains LBS, Browser and Multimedia Messaging Service (MMS), then the LBS can share data sessions with Browser and MMS. Normally an application can only appear in one of the profiles. However, an exception exists for LBS where it can appear in the APPLICATIONS field of multiple profiles, not just one profile. LBS can also appear in all of the user profiles. When an LBS data session needs to be established but there is no existing data session, the profile to be used for establishing the LBS data session will be the one having the least priority among all the profiles containing LBS in the APPLICATIONS field.

Currently 3GPP2 specifications (C.S0023 Rev D or C.S0064 Rev A/B) have EF_{SIPUPPExt}, although it is expected to be renamed EF_{3GPDUPPEXT} but functionality will remain same. It should be appreciated that any usage herein for clarity can focus on the former term while intending to encompass identical or similar implementation by whatever reference.

SIP Profiles are stored in EF_{SIPUPP} and EF_{SIPUPPExt} files. Different applications are associated with different Network Address Identifiers (NAI). Application Type is provided as a 32-bit mask to indicate the applications that use this profile (e.g., Unspecified/Default, Media Message Service (MMS), web browser, JAVA Application, LBS, Binary Runtime Environment for Wireless (BREW) Application, Digital Terminal Equipment (DTE) (e.g., laptop/notebook), etc.). Priority indicates what other applications can share the same data connection.

“RUIM Rev D”/CSIM cards support multiple profiles for Simple IP (SIP) and Mobile IP (MIP) data calls. Each profile has its own index, priority and Application Type (“AppType”) bitmask that support a set of applications. Two or more profiles can possess the same priority. In general, one application should not exist in multiple profiles, but it is possible that a few applications can exist in more than one profile. One such application currently existing is LBS (Location Based Services). Conventionally, the LBS application is not handled in an optimized way to maximize its usage.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

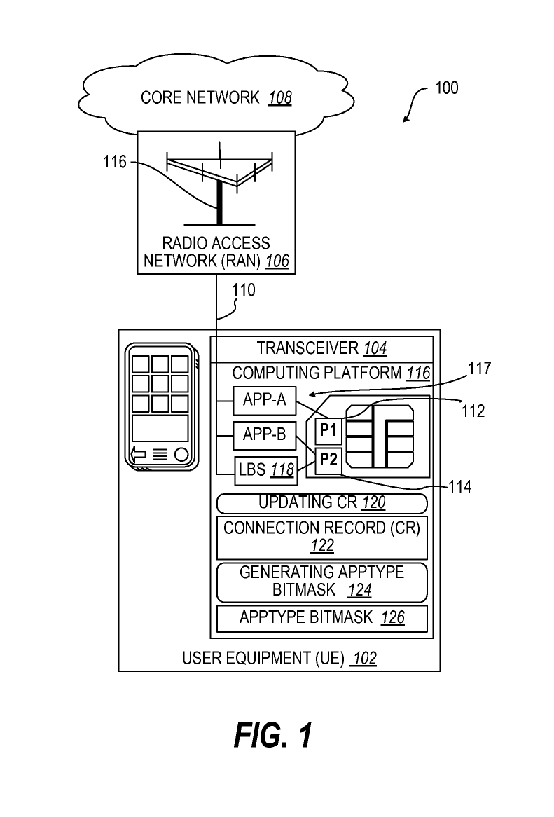

In FIG. 1, in a communication system 100, an apparatus, depicted as User Equipment (UE) 102 communicates via a transceiver 104 with a Radio Access Network (RAN) 106 to a core network 108 for application sharing of a data packet connection 110 using a device provisioned with a plurality of profiles, depicted as user profiles or data structures 112, 114. A computing platform 116 detects opportunities to share the data connection 110 by identifying a supporting one of the plurality of user profiles (“P1”, “P2”) 112, 114 that are associated to an application 117 or service defined for association with multiple profiles, depicted as Location Based Service (LBS) application 118.

In one aspect, the computing platform 116 performs a methodology 120 for identifying the supporting one of the plurality of user profiles 112, 114 by dynamically updating of a connection record 122 to detect an opportunity to share the data connection 110 with the LBS application 118.

In another aspect, the computing platform 116 performs a methodology 124 for generating a data structure, specifically an application type (AppType) bitmask 126, based upon a bitwise logical OR (“|”) operation of a plurality of application types for the plurality of user profiles 112, 114. Thereby, the AppType bitmask 126 can be subsequently used to identify all services supported by the active user profiles 112, 114 to detect an opportunity to share the data connection 110 with the LBS service 118. In an exemplary aspect, each user profile or data structure 112, 114 uses features of an elementary file for simple Internet protocol/Mobile Internet protocol user profile parameters extension (EF_{SIPUPPExt}). Further data connection sharing is otherwise accorded to applications of the same priority that are not precluded from simultaneous execution.

It should be appreciated that in an exemplary aspect, each application can have a priority that depends upon a user profile rather than having an inherent priority. Thus, it should be understood that a need for a priority depends upon whether the applications are assigned to the same user profile or not. One profile may support different kind of applications (e.g., MMS, JAVA, BREW, etc). Given that a user starts two applications and each application needs a different profile, then a priority check is required. However, if a user starts two applications and both need the same profile, then no priority check is required.

Thereby, the apparatus (e.g., UE 102) can avoid instances where a connection is unnecessarily denied. For example, consider a conventional handling of LBS in an illustrative situation of multiple profiles. Assume that Profile 1 (“P1”) 112 supports Application ‘A’ (“App-A”) but does not support an LBS application. Profile 2 (“P2”) 114 supports two applications, namely Application-‘B’ (“App-B”) and the LBS application 118. Given that an end user launches App-A first, then App-A establishes a data connection 110 and uses P1 credentials during Point-to-Point Protocol (PPP) session negotiation. Then, the user launches App-B. App-B shares the existing data connection as both profiles have equal priority. If the user closes App-A, data connection 110 will not be terminated as App-B is still running and sharing the connection 110. Next, the LBS application 118 tries to share the connection 110.

Conventionally, LBS application 118 would be rejected since the data connection 110 was established under P1 that did not support the LBS application 118. In particular, the App-A brought up the connection 110 with P1 attributes. P1 does not support LBS 118. Whereas App-B and LBS belong to same Profile, i.e., P2. App-B is using the interface whereas the LBS application 118 is not allowed. Although the LBS application 118 has all of the requisite capabilities to share the data connection 110, the request by the LBS application 118 is dishonored. This rejection does not make sense since App-B is allowed but not LBS.

In the future, there will be more requirements by network operators to support applications which can exist in multiple profiles like LBS. To utilize such application services to the fullest without violating present OMH and CDMA Development Group (CDG) guidelines, the present innovation introduces an Application Type (“AppType”) bitmask, which can be either temporary or global and can be used to combine the AppType bitmasks of profiles of equal priority. This can be achieved by adding a new Elementary File (EF) item in subscriber identity cards for an application bitmask that can support applications that can reside in multiple SIP/MIP profiles. In an exemplary aspect, it is not necessary to add any EF item for an implementation using RUIM cards. In one aspect, an implementation (“first design”) may not require the disclosed extra EF item for the application bitmask. In another aspect, the disclosed EF item (second design) can be required as discussed.

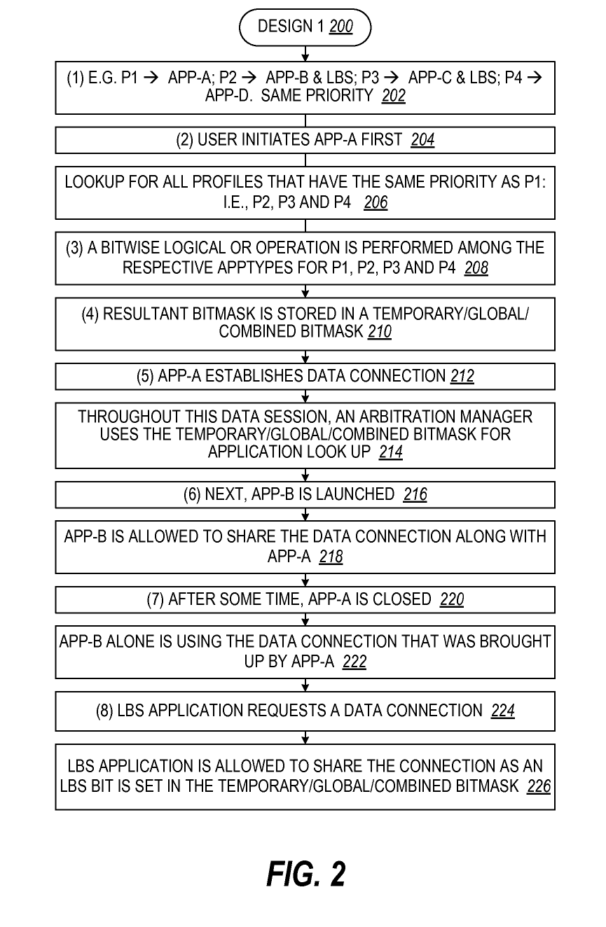

In the first exemplary implementation (first design) depicted in FIG. 2, a methodology 200 for enhanced support for location based services is provided by using a temporary, global or combined application type bitmask. In the exemplary implementation the AppType bitmask is 32-bits. Consider the following illustrative scenario:

(1) Assume Profile 1 (P1) supports App-A only; Profile 2 (P2) supports App-B and LBS; Profile 3 (“P3”) supports an Application-C (“App-C”) and LBS; and Profile 4 (“P4”) supports Application D (“App-D”) only. All Profiles have the same priority (block 202).

(2) A user initiates App-A first (block 204). Lookup is then performed for all profiles that have the same priority as P1. In accordance with point (1), profiles P2, P3 and P4 are identified (block 206).

(3) A bitwise logical OR operation is performed among the respective Application Types (AppType) for profiles P1, P2, P3 and P4 (block 208).

(4) The resultant bitmask is stored in a temporary/global/combined bitmask (block 210).

(5) Next, App-A establishes the data connection (block 214). Throughout this data session, an arbitration manager uses the temporary/global/combined bitmask for application look up (block 214).

(6) Next, App-B is launched (block 216). App-B is allowed to share the data connection along with App-A (block 218).

(7) After some time, App-A is closed (block 220). App-B alone is using the data connection that was brought up by App-A (block 222).

(8) The LBS application requests a data connection (block 224). The LBS application is allowed to share the connection as an LBS bit is set in the temporary/global/combined bitmask (block 226).

By virtue of the foregoing, it should be appreciated with the benefit of the present disclosure that all equal priority applications are allowed to share the data connection without depending on the profile attributes.

For clarity, this exemplary methodology does not consider application priority but rather profile priority. Thus, the applications are considered to be of equal priority and are not configured to be mutually exclusive that would prevent a shared data connection.

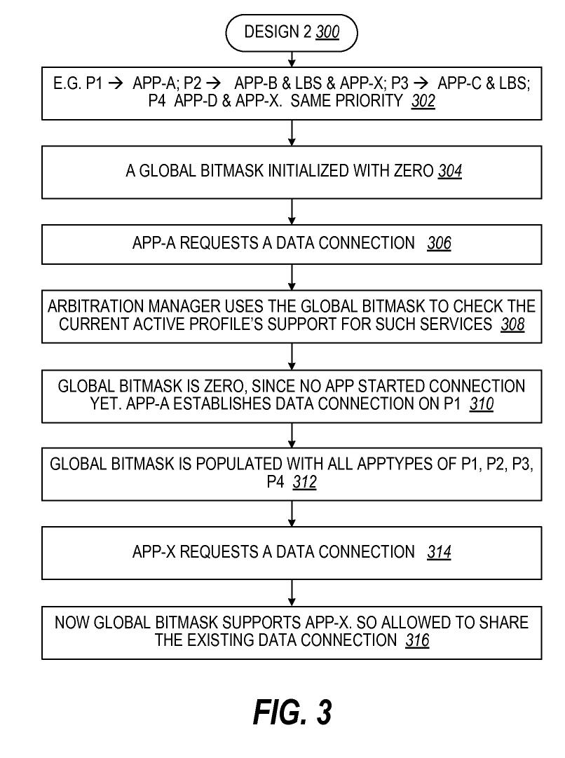

In FIG. 3, an alternative methodology 300 (second design) can address additional aspects for services in multiple profiles.

(1) Assume Profile 1 (P1) supports App-A only; Profile 2 (P2) supports App-B, LBS and Application-X (App-X); Profile 3 (P3) supports App-C and LBS; and Profile-4 (P4) supports App-D and App-X. All Profiles have same priority (block 302).

(2) A global bitmask supports applications that can reside in multiple profiles of same priority. In accordance with point (1) above, bits for LBS and App-X can be enabled in the global bitmask (block 304).

(3) When any application requests a data connection (block 306), an arbitration manager uses the global bitmask to identify profiles that support such services (block 308).

Global AppType Bitmask can only be used for priority profiles that are the same priority and thus cannot be used for other profiles with different priorities. During power-up, the global AppType bitmask is initialized as ZERO indicating no support for any applications.

Thus, when the first application starts, the arbitration manager checks this global AppType bitmask and finds that the first application is not supported. Then the arbitration manager checks whether it is the first application. If it is a new application, the arbitration manager picks up the profile for the application. In this instance App-A establishes a data connection on P1 (block 310). Otherwise if not the first, the arbitration manager will REJECT.

Now once first data connection is established, the arbitration manager populates the global AppType Bitmask with all AppTypes of P1, P2, P3, P4 (block 312).

At this point, App-X is started and requests a data connection (block 314). The arbitration manager checks the global AppType Bitmask, and will find that it is supported, so the arbitration manager allows the App-X to SHARE the connection (block 316).

As described above, using an additional application bitmask can handle the LBS or any other application services supported by multiple profiles.

The exemplary disclosure addresses RUIM Rev D/CSIM SIP/MIP multiple profiles. However, it should be appreciated by one of ordinary skill in the art with the benefit of the present disclosure that the present logic can be applied to any multiple profile concepts irrespective of technology and card types (e.g., RUIM Rev D/CSIM customers, eHRPD carriers, etc.).

The Open Market Handset (OMH) initiative is a strategic effort aimed at enabling CDMA ecosystem with an open market handset distribution of full-featured RUIM-based handsets. This creates broader economies of scale for the entire ecosystem, providing one or more benefits such as increased variety of handsets for end consumers, uplift of Average Revenue Per User (ARPU) for the operators through more feature-rich handsets, easier management of inventory/channel for the distributors, lower handset non-recurring expenditure for the Original Equipment Manufacturer (OEM), shortened time to market for the OEM, and new opportunities to address emerging markets for the OEM.

3GPP2 approved a latest standard “CDMA2000 Application on UICC for Spread Spectrum Systems”, C.S0065-B Version 1.0 Dated Jan. 25, 2010. According to the specification, all CDMA ecosystem variables and features are represented by Elementary Files in C.S0023 Rev D/CSIM (CDMA Subscriber Identify Module) card. Each Elementary File (EF) has its own standardized structure and occupies certain amount of card memory. In particular, a feature has been introduced called “Simple IP User Profile Parameters Extension” represented by Elementary File EF_{SIPUPPExt}. Section 5.2.97 in C.S0065-B version 1.0 illustrates the structure and variables of EF_{SIPUPPEXt} (Elementary File for Simple IP User Profile Parameters Extension). If services n14 (3G Packet Data (3GPD)-SIP) and n35 (Messaging and 3GPD Extensions) are allocated, this EF can be present.

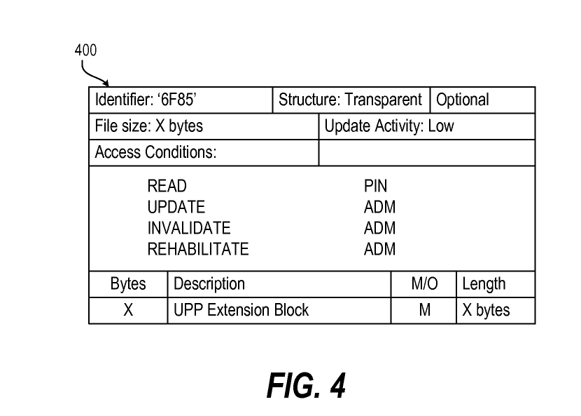

In FIG. 4, this EF as depicted at 400 as containing the additional parameters for Simple IP User Profiles in order to fully support the feature of multiple profiles. Unused bytes can be set to ‘FF’.

UPP Extension Block structure can be employed such as given in TABLE A:

TABLE A

| Field | Length (bits) |
|---|---|
| NUM_NAI | 4 |

NUM_NAI occurrences of the following fields:

| | |
|---|---|
| NAI_ENTRY_INDEX | 4 |
| APPLICATIONS | 32 |
| PRIORITY | 8 |
| DATA_RATE_MODE | 4 |
| DATA_BEARER | 4 |
| RESERVED | 0 OR 4 |

NUM_NAI is a field for a number of UPP Extension instances. This number can be the same as NUM_NAI in the base user profile EF (EF_{SUIPUPP} or EF_{MIPUPP}), where SIPUPP stands for Simple IP User Profile Parameters and MIPUPP stands for Mobile IP User Profile Parameters.

NAI_ENTRY_INDEX is an index to the list of UPP Extension instances. This index can point to the UPP Extension instance that is corresponding to the base UPP instance with the same index value as defined in EF_{SUIPUPP} or EF_{MIPUPP}.

APPLICATIONS is a field that is a bitmask used to indicate which applications are associated with a particular profile. The applications can use the profile having the “Unspecified” bit set in the APPLICATIONS bitmask if they are not present in any other profiles.

TABLE B

| Bit | Application |
|---|---|
| 1 | Unspecified (used by applications not |
| | present in any other profile) |
| 2 | MMS |
| 3 | WAP Browser |
| 4 | Reserved for CDG |
| 5 | Java |
| 6 | Reserved for CDG |
| 7 | Terminal (tethered mode for terminal access) |
| 8-32 | Reserved for future use |

With regard to PRIORITY, when attempting to launch a new application, it is possible that another application is already active and has already established a data session. If the new application has the same PRIORITY value as the previous application that established the existing data session, the new application may simply reuse the existing data session.

If the new application has a different PRIORITY than the previous application that set up the existing data session, the device may use the PRIORITY to determine which application has higher priority, as follows:

TABLE C

| Value | Priority |
|---|---|
| 0 | Highest priority category |
| 1 | Second highest priority category (lower than |
| | 0; higher than 2 and others) |
| 2 | Third highest priority category (lower than |
| | 0 or 1; higher than 3 and others) |
| . . . | . . . |
| 255 | Lowest priority |

DATA_RATE_MODE is depicted in TABLE D:

TABLE D

| Value | Application |
|---|---|
| 0 | Low Speed: Low speed service option only |
| 1 | Medium Speed: F-SCH with service option 33 only |
| 2 | High Speed: F-SCH and R-SCH with service option 33 |
| 3-15 | Reserved for future use |

DATA_BEARER is depicted in TABLE E:

TABLE E

| Value | Application |
|---|---|
| 0 | Hybrid lx/1xEV-DO |
| 1 | lx only |
| 2 | 1xEV-DO only |
| 3-15 | Reserved for future use |

Applications should not be associated with more than one Profile. However, some special services/applications that may not be started always by the end user (i.e., may get initiated by network or Auto Download trigger) can be associated to multiple profiles.

LBS may be associated with multiple profiles because LBS sessions can be initiated by the network through no action of the user. Therefore, this exception allows operators to provision profiles such that LBS may share data sessions with one, many, or all other applications, depending on provisioning of this EF.

Note that handling of data connections in accordance with respective priority of applications as provided by their respective user profiles can be used. To that end, if an incoming application whose user profile indicates a higher PRIORITY requests for a data connection, then the existing application should be torn down. If an incoming application with a lower PRIORITY as indicated by its user profile requests for the data connection, then requesting application should be rejected. If an incoming application with an equal PRIORITY requests for the data connection, then the incoming application should be allowed to share the data connection with the currently running application.

In one aspect, LBS support can be maximized through dynamic updating of a connection record. In particular, the present innovation can build upon handling based upon priority to encompass handling of LBS applications that can be associated to multiple Profiles. To illustrate, consider the following scenario.

Assume two Profiles i.e., Profile 1 and Profile 2 configured in EF_{SIPUPPExt}. Profile 1 and Profile 2 have same PRIORITY. Assume Java application is associated with Profile 1. Brew application and LBS is associated with Profile 2.

The issue is that when Java application is using the data connection, if both Brew application and LBS request for data connection, then Brew application is allowed to share the data connection along with Java application. However, LBS will be rejected because the LBS application is not associated with Profile 1.

Brew application and LBS both are associated to same Profile and have same Priority in fact equal to currently running Java application. Still Brew application is honored and LBS is rejected. This is a conflict.

When both Java and Brew applications are sharing a data connection, if Java application is torn down by a user, then the Brew application alone will use the data connection. Now if LBS again requests a data connection, LBS will still be rejected. The reason is that Java application established data connection so its profile, i.e., Profile 1, does not support LBS. The Brew application and LBS application both are associated to the same profile and have the same priority. When Brew application is running LBS is rejected.

To maximize LBS support, as soon as the Application which has brought up the connection initially is closed, i.e., Java, a check is made as to whether any other active application is associated with the current profile. If yes, then the conventional design can be employed without additional action being needed. If no, then a scan is performed through the rest of the active applications that are currently sharing the connection sequentially and pick up the first profile that support LBS. If no profile with LBS support is found during the scan, then the profile is selected of the immediate next application in order to maintain the consistency in the connection record.

Consider illustrative scenarios using four (4) exemplary profiles, each having the same priority:

Profile 1: Browser, JAVA

Profile 2: BREW, LBS

Profile 3: Wireless Application Protocol (WAP)

Profile 4: MMS, LBS

In a first case, a JAVA application (with profile 1) brings up a connection and BREW (with profile 2) and WAP (with Profile 3) share it. Then, the JAVA application closes. Since the Java application that brought up the connection closed, a first innovative aspect can be employed. First, a check is made whether there is any other active application associated with profile 1. In this case, there is not. Second, a scan is made of the other applications to pick the profile that supports LBS. In this instance, BREW and WAP are the running applications. Since Profile 2 used by BREW application supports LBS, Profile 2 is picked and updated. Subsequently, when an LBS application request for connection is made, the existing connection will continue to support LBS and the request can be allowed.

In a second case, the JAVA application (with profile 1) has brought up the connection and BREW (with profile 2) and MMS (with Profile 4) are sharing it. Now JAVA closes. Since the Java application that brought up the connection is closed, the innovative aspect can be employed. First, a check is made as to whether there is any other active application associated with profile 1. In this case, there are none. Second a scan is made for the rest of the applications (i.e., BREW and MMS to pick the profile which supports LBS). In this instance, both BREW and MMS profiles support LBS Applications. Third, a sequential scan is performed with the first successful search being picked (e.g., Profile 2). Thereby, LBS support is improved by allowing a subsequent LBS application to access the connection. By increasing availability of LBS applications, users can benefit by having the most up-to-date information. Network operators can also benefit by realizing increased revenues from providing LBS application services.

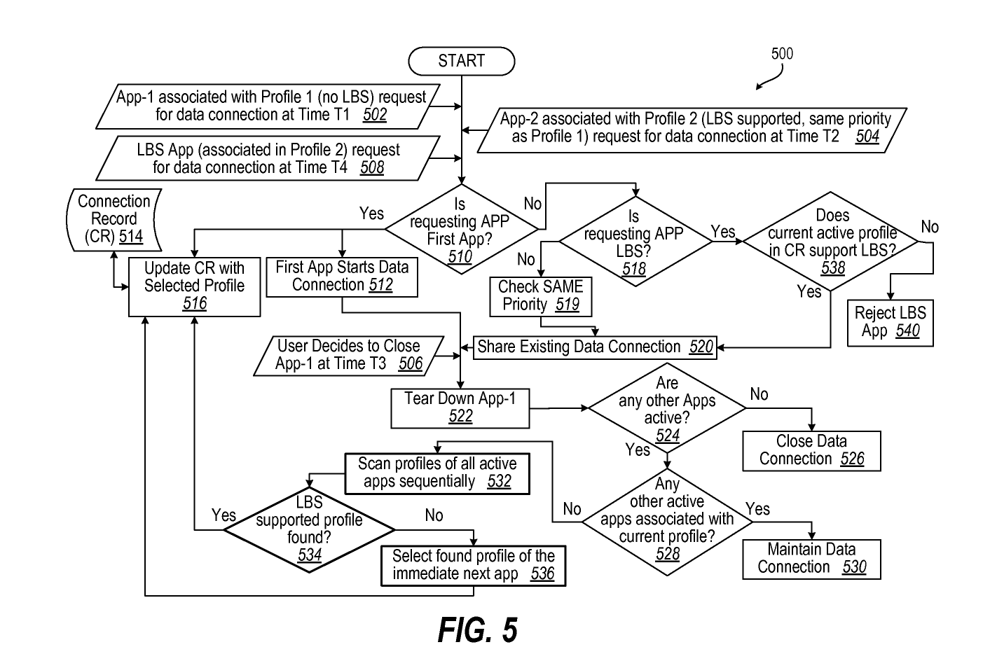

In FIG. 5, a flow diagram depicting a methodology 500 is provided for updating a connection record to increase opportunities for providing a data connection to an LBS application. A first application (App-1) that is associated to a first profile (P1) that does not support LBS requests a data connection at Time T1 (block 502). Subsequently, a second application (App-2), which is associated to a second profile (P2) that supports LBS and has the same priority as P1, requests a data connection at Time T2 (block 504). Subsequently, a user decides to close App-1 at Time T3 (block 506). Subsequently, the LBS application associated to P2 requests a data connection at Time T4 (block 508). These external inputs are addressed as follows.

A determination is made whether each of the requests for a data connection are first (i.e., a data connection was not previously established) (block 510). If yes, such as for block 502, then the first application is allowed to start a data connection (block 512). In addition, the present innovation provides for dynamically updating a Connection Record (CR) 514 with selected profile information (block 516).

If the determination at block 510 is that the requesting application is not the first (e.g., after block 504 or block 508), then a further determination is made as to whether the requesting application is LBS (block 518). A check is made for priority that is the same so that the applications can share the same connection (block 519). Then, in the instance of block 504, the requesting application is not LBS, so the result is that the existing data connection is shared (block 520).

When the App-1 is closed at block 506, then a tear down occurs (block 522). A determination is made as to whether there are any other applications active (block 524). If this were not true, then the data connection would be closed (block 526). However App-2 is sharing the connection, so a further determination is made as to whether any other active applications are associated with the current profile (block 528). If so, the data connection can be maintained without changing to the connection record regarding other profiles (block 530). Otherwise, if the active applications are associated with another profile, then a dynamic scan is performed of all active applications sequentially (block 532). A determination is made as to whether a profile has been found that supports LBS (block 534). If so, this found profile of the next application is selected (block 536). Processing returns to block 516 to update with the results of the scan.

Thus, at time T4 when the LBS application requests a data connection in block 508, the determination at block 510 is that the requesting application is not the first and the determination at block 518 is that the requesting application is LBS. For this case, a further determination is made as to whether the current active profile in the connection record supports LBS (block 538). If not, then the LBS application request is rejected (block 540). However, in this scenario, P2 is active and does support LBS. Thus, the LBS application is allowed to share the existing data connection in block 520.

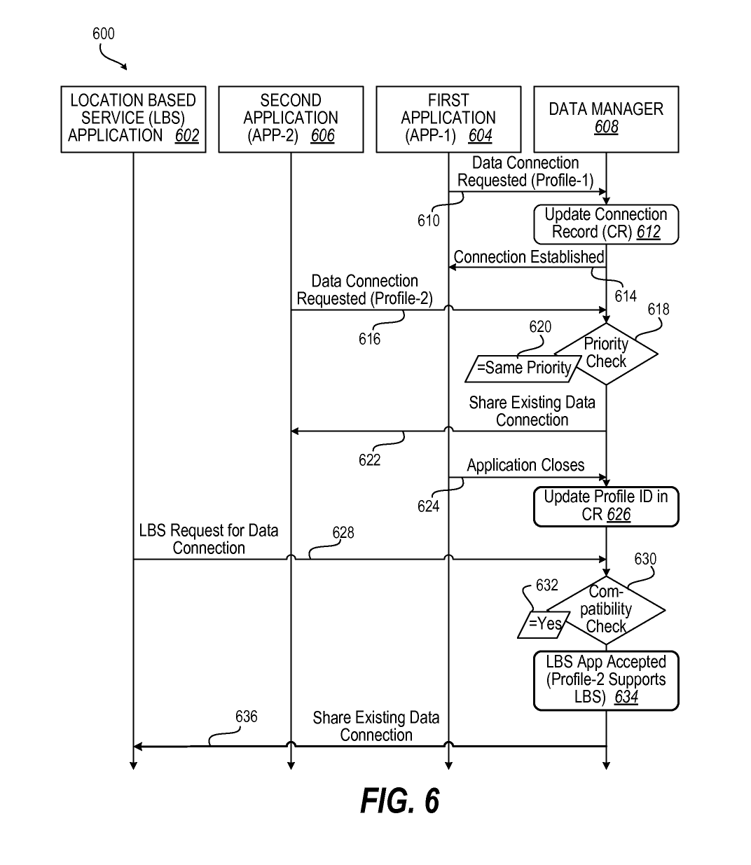

In FIG. 6, a timing diagram depicts an exemplary methodology 600 performed by an LBS application 602, a first application (App-1) 604, a second application (App-2) 606 and a data manager 608. As depicted at 610, a data connection is requested by App-1 604 using Profile 1. The data manager 608 updates the connection record (block 612). The data manager 608 establishes the connection for the App-1 604 as depicted at 614. Then the App-2 606 requests a data connection using Profile 2 as depicted at 616. The data manager 608 performs a priority check to determine if App-2 606 has the same priority as the current App-1 604 (block 618). In this instance, the same priority is found (block 620); thus a shared data connection is allowed as depicted at 622.

Then App-1 604 closes as depicted at 624. The data manager 608 updates the profile index/identifier in the connection record (block 626). Thus, the data manager 608 is prepared for when the LBS application 602 requests a data connection at 628 by performing a compatibility check (block 630). Compatibility is found (block 632). Thus, the LBS application 602 is accepted since Profile 2 supports LBS (block 634). The existing data connection is shared as depicted at 636.

In another aspect, support of LBS application can be maximized using a global application bitmask. For example, assume two Profiles, i.e., Profile 1 and Profile 2 configured in EF_{SIPUPPExt}. Profile 1 and Profile 2 have same PRIORITY. Assume Java application is associated with Profile 1. Brew application and LBS is associated with Profile 2.

The issue is that when Java application is using the data connection, if both Brew application and LBS request for data connection then Brew application is allowed to share the data connection along with Java application, but LBS will be rejected. The reason is that LBS application is not associated with Profile 1. Brew application and LBS both are associated to same Profile and have same Priority in fact equal to currently running Java application. Still Brew application is honored and LBS is declined. This is a conflict.

In future, there will be more requirements by network operators to support applications that can be associated with multiple profiles similar to LBS. To make available such applications to the fullest to end user, an additional global Application Bitmask aggregates the support of all profiles having same priority and can be used for compatibility check for LBS instead of current active profile ID.

Network operator can benefit by improving availability of the LBS application, thus boosting revenue. Users can benefit by having the most updated information.

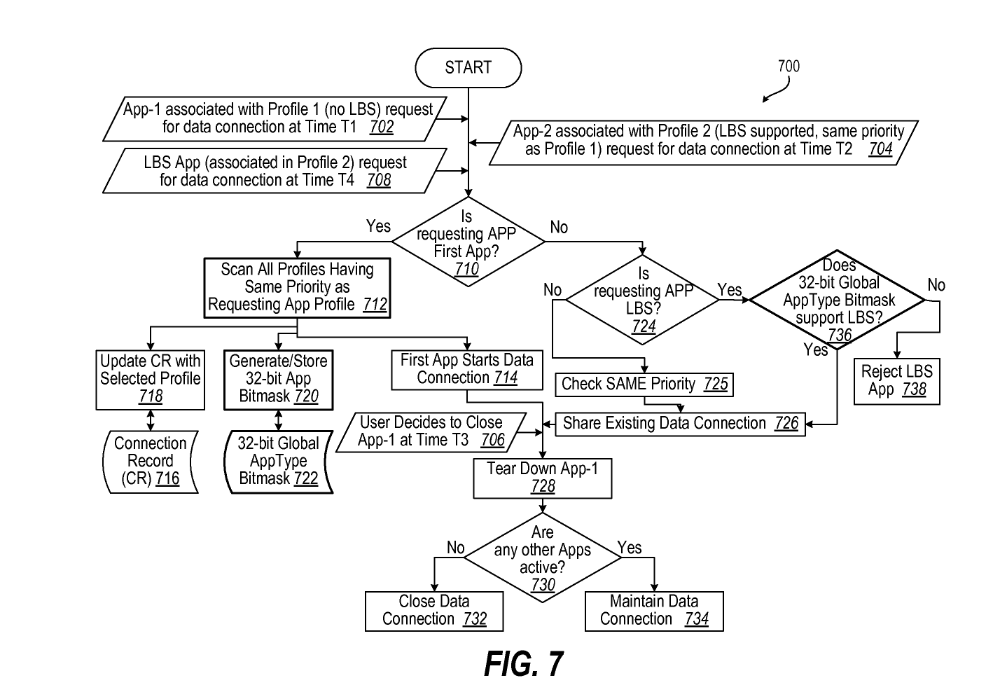

In FIG. 7, a flow diagram depicting a methodology 700 is provided for a global application bitmask to increase opportunities for providing a data connection to an LBS application. A first application (App-1) that is associated to a first profile (P1) that does not support LBS requests a data connection at Time T1 (block 702). Subsequently, a second application (App-2), which is associated to a second profile (P2) that supports LBS and has the same priority as P1, requests a data connection at Time T2 (block 704). Subsequently, a user decides to close App-1 at Time T3 (block 706). Subsequently, the LBS application associated to P2 requests a data connection at Time T4 (block 708). These external inputs are addressed as follows.

A determination is made whether each of the requests for a data connection are first (i.e., a data connection was not previously established) (block 710). If yes, such as for block 702, then all profiles having the same priority as the requesting application are scanned (block 712). The first application is allowed to start a data connection (block 714). In addition, the present innovation provides for dynamically updating a Connection Record (CR) 716 with selected profile information (block 718). A 32-bit global application type (AppType) bitmask is generated (block 720). The bitmask is stored in a data structure 722 for subsequent checks.

If the determination at block 710 is that the requesting application is not the first (e.g., after block 704 or block 708), then a further determination is made as to whether the requesting application is LBS (block 724). A check is made to see that both profiles have the same priority so that the applications can share the same connection (block 725). Then in the instance of block 704, the requesting application is not LBS, so the result is that the existing data connection is shared (block 726).

When the App-1 is closed at block 706, then a tear down occurs (block 728). A determination is made as to whether there are any other applications active (block 730). If this were none, then the data connection would be closed (block 732). However, App-2 is sharing the connection, so the data connection is maintained (block 734).

At Time T4 (block 708), the determination at block 710 is that the requesting application is LBS. Thus, a further determination is made as to whether the current 32-bit global AppType bitmask supports LBS (block 736). If not, the LBS application is rejected (block 738). Otherwise, the LBS application is allowed to share the connection (block 726).

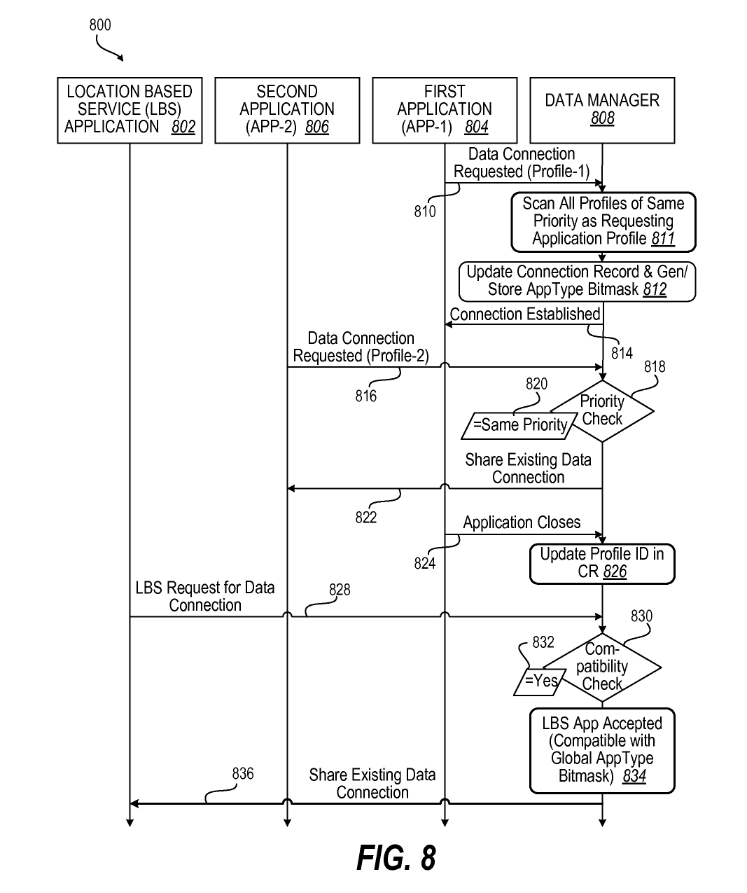

In FIG. 8, a timing diagram depicts an exemplary methodology 800 performed by an LBS application 802, a first application (App-1) 804, a second application (App-2) 806 and a data manager 808. As depicted at 810, a data connection is requested by App-1 804 using Profile 1. A scan is performed for all profiles of the same priority as the requesting application profile (block 811). The data manager 808 updates the connection record and generates/stores the global AppType bitmask (block 812). The data manager 808 establishes the connection for the App-1 804 as depicted at 814. Then the App-2 806 requests a data connection using Profile 2 as depicted at 816. The data manager 808 performs a priority check to determine if App-2 806 has the same priority as the current App-1 804 (block 818). In this instance, the same priority is found (block 820); thus a shared data connection is allowed as depicted at 822.

Then App-1 804 closes as depicted at 824. The data manager 808 updates the profile identifier in the connection record (block 826). Thus, the data manager 808 is prepared for when the LBS application 802 requests a data connection at 828 by performing a compatibility check (block 830). Compatibility is found (block 832). Thus, the LBS application 802 is accepted since Profile 2 supports LBS (block 834). The existing data connection is shared as depicted at 836.

It should be appreciated by virtue of the foregoing that use of a Global temporary variable is an exemplary alternative to updating a Connection Record. Updating of the Connection Record can be omitted if global AppType bitmask is generated and stored. This omission is enabled because the arbitration manager (“DataMgr”) can perform a compatibility check using the global AppType Bitmask when an LBS application requests a data connection (FIGS. 7-8). By contrast, in FIGS. 5-6, a compatibility check with APPLICATIONS field is performed of an updated profile ID in CR.

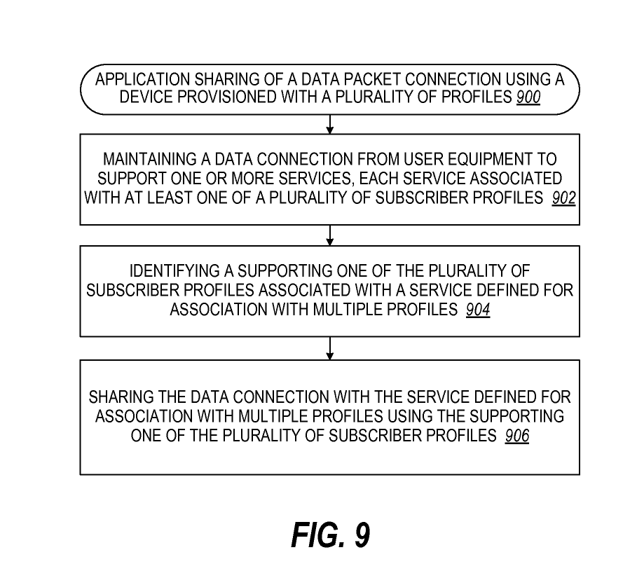

In FIG. 9, a methodology or sequence of operations 900 is depicted for application sharing of a data packet connection using a device provisioned with a plurality of profiles. A data connection is maintained from user equipment to support one or more services, each service associated with at least one of a plurality of user profiles (block 902). A supporting one is identified of the plurality of user profiles associated with a service defined for association with multiple profiles (block 904). The data connection is shared with the service defined for association with multiple profiles using the supporting one of the plurality of user profiles (block 906).

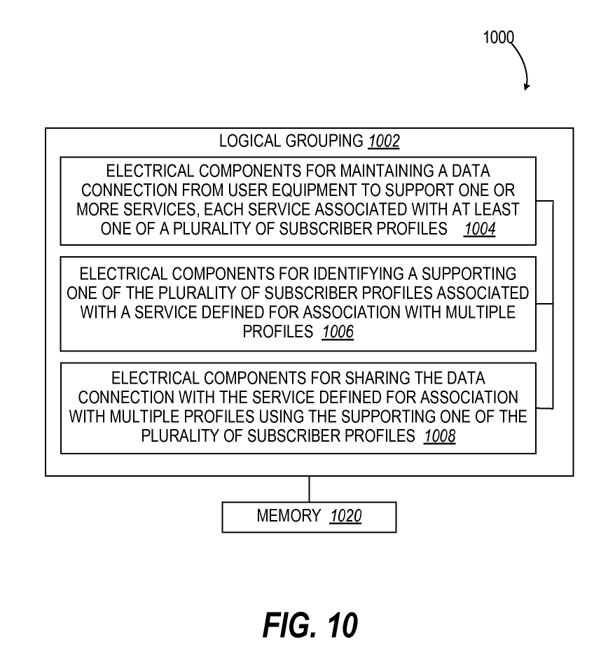

With reference to FIG. 10, illustrated is a system 1000 for application sharing of a data packet connection using a device provisioned with a plurality of profiles. For example, system 1000 can reside at least partially within user equipment (UE). It is to be appreciated that system 1000 is represented as including functional blocks, which can be functional blocks that represent functions implemented by a computing platform, processor, software, or combination thereof (e.g., firmware). System 1000 includes a logical grouping 1002 of electrical components that can act in conjunction. For instance, logical grouping 1002 can include an electrical component for maintaining a data connection from user equipment to support one or more services, each service associated with at least one of a plurality of user profiles 1004. Moreover, logical grouping 1002 can include an electrical component for identifying a supporting one of the plurality of user profiles associated with a service defined for association with multiple profiles 1006. For another instance, logical grouping 1002 can include an electrical component for sharing the data connection with the service defined for association with multiple profiles using the supporting one of the plurality of user profiles 1008. Additionally, system 1000 can include a memory 1020 that retains instructions for executing functions associated with electrical components 1004-1008. While shown as being external to memory 1020, it is to be understood that one or more of electrical components 1004-1008 can exist within memory 1020.

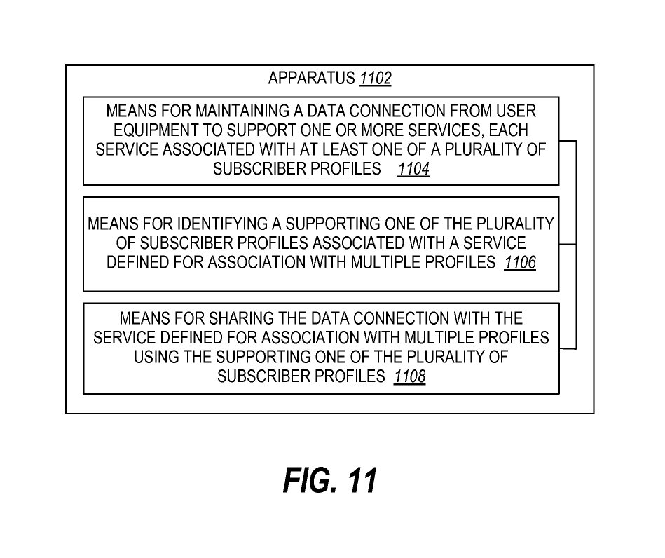

In FIG. 11, an apparatus 1102 is depicted for application sharing of a data packet connection using a device provisioned with a plurality of profiles. Means 1104 are provided for maintaining a data connection from user equipment to support one or more services, each service associated with at least one of a plurality of user profiles. Means 1106 are provided for identifying a supporting one of the plurality of user profiles associated with a service defined for association with multiple profiles. Means 1108 are provided for sharing the data connection with the service defined for association with multiple profiles using the supporting one of the plurality of user profiles.

It should be appreciated that wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP LTE systems, and orthogonal frequency division multiple access (OFDMA) systems.

A wireless multiple-access communication system may simultaneously support communication for multiple wireless access terminals. As mentioned above, each terminal may communicate with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out system, a multiple-in-multiple-out (“MIMO”) system, or some other type of system.

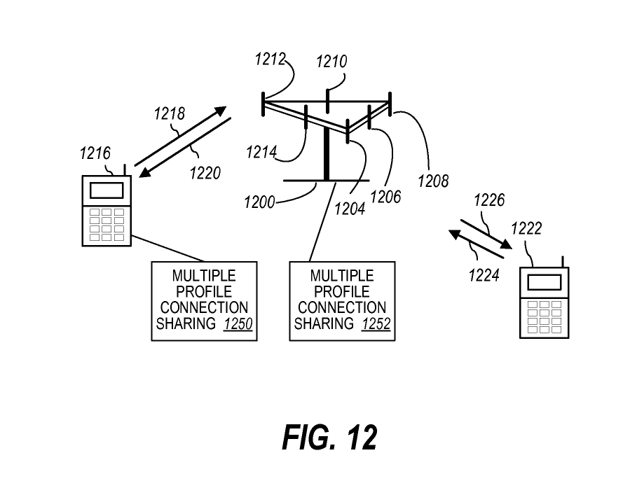

Referring to FIG. 12, a multiple access wireless communication system according to one aspect is illustrated. An access point (AP) 1200 includes multiple antenna groups, one including 1204 and 1206, another including 1208 and 1210, and an additional including 1212 and 1214. In FIG. 12, only two antennas are shown for each antenna group, however, more or fewer antennas may be utilized for each antenna group. Access terminal (AT) 1216 is in communication with antennas 1212 and 1214, where antennas 1212 and 1214 transmit information to access terminal 1216 over forward link 1220 and receive information from access terminal 1216 over reverse link 1218. Access terminal 1222 is in communication with antennas 1206 and 1208, where antennas 1206 and 1208 transmit information to access terminal 1222 over forward link 1226 and receive information from access terminal 1222 over reverse link 1224. In a FDD system, communication links 1218, 1220, 1224 and 1226 may use different frequencies for communication. For example, forward link 1220 may use a different frequency then that used by reverse link 1218.

Each group of antennas and/or the area in which they are designed to communicate is often referred to as a sector of the access point 1200. In the aspect, antenna groups each are designed to communicate to access terminals 1216 and 1222 in a sector of the areas covered by access point 1200.

In communication over forward links 1220 and 1226, the transmitting antennas of access point 1200 utilize beam forming in order to improve the signal-to-noise ratio of forward links for the different access terminals 1216 and 1222. Also, an access point using beam forming to transmit to access terminals scattered randomly through its coverage causes less interference to access terminals in neighboring cells than an access point transmitting through a single antenna to all of its access terminals.

An access point 1200 may be a fixed station used for communicating with the terminals and may also be referred to as an access point, a Node B, or some other terminology. An access terminal 1216 and 1222 may also be called user equipment (UE), a wireless communication device, terminal, or some other terminology.

The access terminal 1216 and access point 1200 can respectively incorporate a multiple profile connection sharing component 1250, 1252 for performing the afore-mentioned aspects.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels (N_{S}), where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

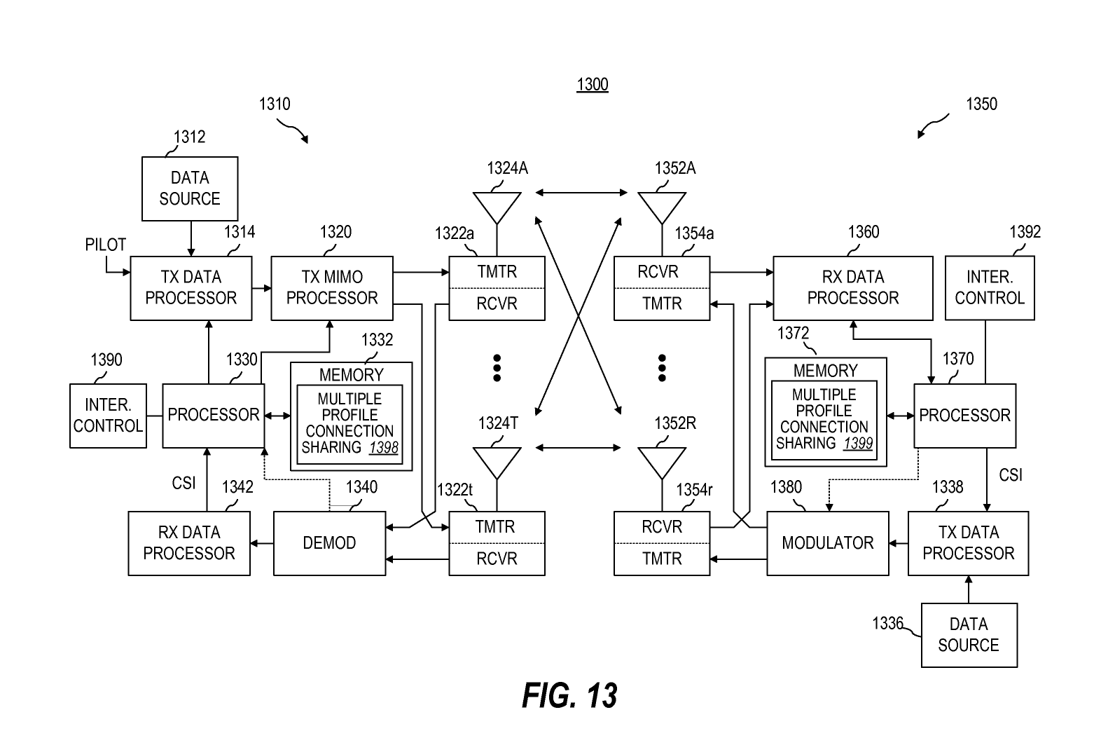

The teachings herein may be incorporated into a node (e.g., a device) employing various components for communicating with at least one other node. FIG. 13 depicts several sample components that may be employed to facilitate communication between nodes. Specifically, FIG. 13 illustrates a wireless device 1310 (e.g., an access point) and a wireless device 1350 (e.g., an access terminal) of a MIMO system 1300. At the device 1310, traffic data for a number of data streams is provided from a data source 1312 to a transmit (“TX”) data processor 1314.

In some aspects, each data stream is transmitted over a respective transmit antenna. The TX data processor 1314 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., Binary Phase Shift Keying (BPSK), Quadrature Phase-Shift Keying (QPSK), M-ary Phase Shift Keying (M-PSK), or Multiple Quadrature Amplitude Modulation (M-QAM)) selected for that data stream to provide modulation symbols. The data rate, coding, and modulation for each data stream may be determined by instructions performed by a processor 1330. A data memory 1332 may store program code, data, and other information used by the processor 1330 or other components of the device 1310.

The modulation symbols for all data streams are then provided to a TX MIMO processor 1320, which may further process the modulation symbols (e.g., for OFDM). The TX MIMO processor 1320 then provides N_{T} modulation symbol streams to N_{T} transceivers (“XCVR”) 1322a-1322t that each has a transmitter (TMTR) and receiver (RCVR). In some aspects, the TX MIMO processor 1320 applies beamforming weights to the symbols of the data streams and to the antenna from which the symbol is being transmitted.

Each transceiver 1322a-1322t receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1322a-1322t are then transmitted from N_{T} antennas 1324a-1324t, respectively.

At the device 1350, the transmitted modulated signals are received by N_{R} antennas 1352a-1352r and the received signal from each antenna 1352a-1352r is provided to a respective transceiver (“XCVR”) 1354a-1354r. Each transceiver 1354a-1354r conditions (e.g., filters, amplifies, and downconverts) a respective received signal, digitizes the conditioned signal to provide samples, and further processes the samples to provide a corresponding “received” symbol stream.

A receive (“RX”) data processor 1360 then receives and processes the N_{R} received symbol streams from N_{R} transceivers 1354a-1354r based on a particular receiver processing technique to provide N_{T} “detected” symbol streams. The RX data processor 1360 then demodulates, deinterleaves, and decodes each detected symbol stream to recover the traffic data for the data stream. The processing by the RX data processor 1360 is complementary to that performed by the TX MIMO processor 1320 and the TX data processor 1314 at the device 1310.

A processor 1370 periodically determines which pre-coding matrix to use. The processor 1370 formulates a reverse link message comprising a matrix index portion and a rank value portion. A data memory 1372 may store program code, data, and other information used by the processor 1370 or other components of the device 1350.

The reverse link message may comprise various types of information regarding the communication link and/or the received data stream. The reverse link message is then processed by a TX data processor 1338, which also receives traffic data for a number of data streams from a data source 1336, modulated by a modulator 1380, conditioned by the transceivers 1354a-1354r, and transmitted back to the device 1310.

At the device 1310, the modulated signals from the device 1350 are received by the antennas 1324a-1324t, conditioned by the transceivers 1322a-1322t, demodulated by a demodulator (“DEMOD”) 1340, and processed by a RX data processor 1342 to extract the reverse link message transmitted by the device 1350. The processor 1330 then determines which pre-coding matrix to use for determining the beam-forming weights then processes the extracted message.

FIG. 13 also illustrates that the communication components may include one or more components that perform interference control operations. For example, an interference (“INTER.”) control component 1390 may cooperate with the processor 1330 and/or other components of the device 1310 to send/receive signals to/from another device (e.g., device 1350). Similarly, an interference control component 1392 may cooperate with the processor 1370 and/or other components of the device 1350 to send/receive signals to/from another device (e.g., device 1310). It should be appreciated that for each device 1310 and 1350 the functionality of two or more of the described components may be provided by a single component. For example, a single processing component may provide the functionality of the interference control component 1390 and the processor 1330 and a single processing component may provide the functionality of the interference control component 1392 and the processor 1370.

The wireless device 1310 (e.g., an access point) and wireless device 1350 (e.g., an access terminal) can respectively incorporate a multiple profile connection sharing component 1398, 1399 for performing the afore-mentioned aspects.

It should be apparent that the teaching herein can be embodied in a wide variety of forms and that any specific structure or function disclosed herein is merely representative. Based on the teachings herein one skilled in the art should appreciate that an aspect disclosed herein can be implemented independently of other aspects and that two or more of these aspects can be combined in various ways. For example, an apparatus can be implemented or a method practiced using any number of the aspects set forth herein. In addition, an apparatus can be implemented or a method practiced using other structure or functionality in addition to or other than one or more of the aspects set forth herein. As an example, many of the methods, devices, systems, and apparatuses described herein are described in the context of providing dynamic queries and recommendations in a mobile communication environment. One skilled in the art should appreciate that similar techniques could apply to other communication and non-communication environments as well.

As used in this disclosure, the term “content” and “objects” are used to describe any type of application, multimedia file, image file, executable, program, web page, script, document, presentation, message, data, meta-data, or any other type of media or information that may be rendered, processed, or executed on a device.

As used in this disclosure, the terms “component,” “system,” “module,” and the like are intended to refer to a computer-related entity, either hardware, software, software in execution, firmware, middle ware, microcode, or any combination thereof. For example, a component can be, but is not limited to being, a process running on a processor, a processor, an object, an executable, a thread of execution, a program, or a computer. One or more components can reside within a process or thread of execution and a component can be localized on one computer or distributed between two or more computers. Further, these components can execute from various computer readable media having various data structures stored thereon. The components can communicate by way of local or remote processes such as in accordance with a signal having one or more data packets (e.g., data from one component interacting with another component in a local system, distributed system, or across a network such as the Internet with other systems by way of the signal). Additionally, components of systems described herein can be rearranged or complemented by additional components in order to facilitate achieving the various aspects, goals, advantages, etc., described with regard thereto, and are not limited to the precise configurations set forth in a given figure, as will be appreciated by one skilled in the art.

Additionally, the various illustrative logics, logical blocks, modules, and circuits described in connection with the aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the operations or actions described herein.

Moreover, various aspects or features described herein can be implemented as a method, apparatus, or article of manufacture using standard programming or engineering techniques. Further, the operations or actions of a method or algorithm described in connection with the aspects disclosed herein can be embodied directly in hardware, in a software module executed by a processor, or in a combination of the two. Additionally, in some aspects, the operations or actions of a method or algorithm can reside as at least one or any combination or set of codes or instructions on a machine-readable medium or computer readable medium, which can be incorporated into a computer program product. Further, the term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, various storage media described herein can represent one or more devices or other machine-readable media for storing information. The term “machine-readable medium” can include, without being limited to, wireless channels and various other media capable of storing, containing, or carrying instruction, or data.

Furthermore, various aspects are described herein in connection with an apparatus that is a mobile device. A mobile device can also be called a system, a subscriber unit, a subscriber station, mobile station, mobile, cellular device, multi-mode device, remote station, remote terminal, access terminal, user terminal, user agent, a user device, or user equipment, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device. Further, aspects can be employed by an apparatus that is a fixed or portable device communicating at least in part by an air link.

In addition to the foregoing, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Furthermore, as used in this application and the appended claims, the term “or” is intended to mean an inclusive “or” rather than an exclusive “or.” That is, unless specified otherwise, or clear from context, “X employs A or B” is intended to mean any of the natural inclusive permutations. That is, in this example, X could employ A, or X could employ B, or X could employ both A and B, and thus the statement “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or deducing states of a system, environment, or user from a set of observations as captured via events or data. Inference can be employed to identify a specific context or action, or can generate a probability distribution over states, for example. The inference can be probabilistic--that is, the computation of a probability distribution over states of interest based on a consideration of data and events. Inference can also refer to techniques employed for composing higher-level events from a set of events or data. Such inference results in the construction of new events or actions from a set of observed events or stored event data, whether or not the events are correlated in close temporal proximity, and whether the events and data come from one or several event and data sources.

Variations, modification, and other implementations of what is described herein will occur to those of ordinary skill in the art without departing from the spirit and scope of the disclosure as claimed. Accordingly, the disclosure is to be defined not by the preceding illustrative description but instead by the spirit and scope of the following claims.

What is claimed is:

1. A method for application sharing of a data packet connection using a device provisioned with a plurality of profiles, comprising:
maintaining a data connection from user equipment to support one or more services, each service associated with at least one of a plurality of user profiles;
identifying a supporting one of the plurality of user profiles associated with a service defined for association with multiple profiles; and
sharing the data connection with the service defined for association with multiple profiles using the supporting one of the plurality of user profiles.

2. The method of claim 1, wherein identifying the supporting one of the plurality of user profiles further comprises dynamically updating of a connection record to detect an opportunity to share the data connection with the service defined for association with multiple profiles.

3. The method of claim 1, wherein identifying the supporting one of the plurality of user profiles further comprises generating a data structure identifying all services supported by the data connection to detect an opportunity to share the data connection with the service defined for association with multiple profiles.

4. The method of claim 3, wherein generating the data structure further comprises generating a bitmask based upon a bitwise logical OR operation of a plurality of application types for the plurality of user profiles.

5. The method of claim 1, wherein sharing the data connection with the service defined for association multiple profiles further comprises sharing the data connection with a location based service.

6. The method of claim 1, wherein identifying the supporting one of the plurality of user profiles further comprises accessing an applications field of an elementary file for simple Internet protocol user profile parameters extension.

7. The method of claim 1, wherein sharing the data connection with the service defined for association with multiple profiles using the supporting one of the plurality of user profiles further comprises sharing the data connection among applications associated to respective ones of the plurality of user profiles that have the same priority.

8. At least one processor for application sharing of a data packet connection using a device provisioned with a plurality of profiles, comprising:
a first module for maintaining a data connection from user equipment to support one or more services, each service associated with at least one of a plurality of user profiles;
a second module for identifying a supporting one of the plurality of user profiles associated with a service defined for association with multiple profiles; and
a third module for sharing the data connection with the service defined for association with multiple profiles using the supporting one of the plurality of user profiles.

9. A computer program product for application sharing of a data packet connection using a device provisioned with a plurality of profiles, comprising:
a non-transitory computer-readable storage medium comprising:
a first set of codes for causing a computer to maintain a data connection from user equipment to support one or more services, each service associated with at least one of a plurality of user profiles;
a second set of codes for causing the computer to identify a supporting one of the plurality of user profiles associated with a service defined for association with multiple profiles; and
a third set of codes for causing the computer to share the data connection with the service defined for association with multiple profiles using the supporting one of the plurality of user profiles.

10. An apparatus for application sharing of a data packet connection using a device provisioned with a plurality of profiles, comprising:
means for maintaining a data connection from user equipment to support one or more services, each service associated with at least one of a plurality of user profiles;
means for identifying a supporting one of the plurality of user profiles associated with a service defined for association with multiple profiles; and
means for sharing the data connection with the service defined for association with multiple profiles using the supporting one of the plurality of user profiles.

11. An apparatus for application sharing of a data packet connection using a device provisioned with a plurality of profiles, comprising:
a transceiver for maintaining a data connection from user equipment to support one or more services, each service associated with at least one of a plurality of user profiles; and
a computing platform for identifying a supporting one of the plurality of user profiles associated with a service defined for association with multiple profiles, and for sharing the data connection with the service defined for association with multiple profiles using the supporting one of the plurality of user profiles.

12. The apparatus of claim 11, wherein the computing platform is further for identifying the supporting one of the plurality of user profiles by dynamically updating of a connection record to detect an opportunity to share the data connection with the service defined for association with multiple profiles.

13. The apparatus of claim 11, wherein the computing platform is further for identifying the supporting one of the plurality of user profiles by generating a data structure identifying all services supported by the data connection to detect an opportunity to share the data connection with the service defined for association with multiple profiles.

14. The apparatus of claim 13, wherein the computing platform is further for generating the data structure by generating a bitmask based upon a bitwise logical OR operation of a plurality of application types for the plurality of user profiles.

15. The apparatus of claim 11, wherein the computing platform is further for sharing the data connection with the service defined for association multiple profiles by sharing the data connection with a location based service.

16. The apparatus of claim 11, wherein the computing platform is further for identifying the supporting one of the plurality of user profiles by accessing an applications field of an elementary file for simple Internet protocol user profile parameters extension.

17. The apparatus of claim 11, wherein the transceiver is further for sharing the data connection with the service defined for association with multiple profiles using the supporting one of the plurality of user profiles by sharing the data connection among applications associated to respective ones of the plurality of user profiles that have the same priority.
